(19) United States
(12) Patent Application Publication
(10) Pub. No.: US 2009/0265340 A1
(43) Pub. Date: Oct. 22, 2009

(54) Proximity search for point-of-interest names combining inexact string match with an expanding radius search

(76) Inventors: Bob Barcklay, Berkeley, CA (US); John R. Hahn, San Francisco, CA (US)

Correspondence Address: MANELLI DENISON & SELTER PLLC, 7th Floor, 2000 M Street, N.W., Washington, DC, 20036-3307, US

(21) Appl. No.: 12/385,294

(22) Filed: Apr. 3, 2009

Related U.S. Application Data
(60) Provisional application No. 61/064,986, filed on Apr. 7, 2008.

(51) Int. Cl. G06F 17/30; G01C 21/26

(52) U.S. Cl. 707/5; 701/208; 707/E17.109; 707/E17.018

(57) ABSTRACT

A point-of-interest mapping search system that combines inexact string searches with a proximity search to provide an extremely high probability of return of a set of search results in an initial search response that are useful to the user. Relevance of any particular point-of-interest item in a combined inexact string/proximity is dependent on both (1) a quality of the name match; and (2) a proximity to the starting location (or other relevant search center point) of the POI search. The inexact string name/proximity search is performed efficiently by iteratively expanding a search radius around a given location, searching concentric circles of proximity until a specified target number of relevant results have been found. It is the combination of the use of a combined inexact string match together with a proximity search performed against a database of geo-referenced business names that provides advantageous results.

The present application claims priority from U.S. Provisional Appl. No. 61/064,986, entitled “Proximity Search For Business Names Combining Inexact String Match With an Expanding Radius Search” to Barcklay et al., the entirety of which is explicitly incorporated herein by reference.

### BACKGROUND OF THE INVENTION

1. Field of the Invention

This invention relates generally to wireless telecommunication, and location based services. In particular, it relates to location based applications providing proximity based search services.

2. Background of the Related Art

Currently with mapping applications on mobile phones, a user can search for point-of-interest (POI) icons based on user selected search criterion. The user may view the resultant point-of-interest as icons on a map where the location of an icon is representative of the location (street address) of the corresponding point-of-interest.

To search these POI icons, consumer-based search services typically support some kind of inexact string matching alternative search to assist the user in an attempt to find the most relevant results—even if a name is misspelled or only partially supplied. For example, GOOGLE™ Maps wireless application (as well as the web site available at maps.google.com) provides search results that are always an exact match on the string provided, but additionally may include a ‘Did you mean . . . ’ alternative search link displayed at the top of the page, offering another choice of search string that may be more relevant than the one provided.

FIG. 3 is a conventional example showing the results provided at maps.google.com, wherein a ‘Find business’ search is performed with user input of ‘What’=‘Starbocks’ and ‘Where’=‘Berkeley, Calif.’.

In particular, as shown in FIG. 3, the user had intended to input ‘What’=‘Starbucks’, but erroneously typed in ‘Starbocks’.

In response, a conventional searching system such as GOOGLE™ Maps provides the results for two different POI inputs: a first search for POIs called “Farella Braun & Martel Llp” with included text on the web page indicating associated blog text discussing a bear called “Star Bock Beer”. The other POI search returned identifies a location called “Abrahamson Group, PC” with included text having no apparent connection to even the erroneously spelled input. It is to be noted that these results typically change frequently, but the basic behavior is unchanged.

Conventional systems such as GOOGLE™ Maps provides an alternative search to an inexactly matched text stream. In particular, the ‘Did you mean’ alternate search of GOOGLE™ Maps has in the past provided a suggested search of ‘Stardock”. A more recent search for the same ‘Stardock’ has provided more accurate results. For instance, while the GOOGLE™ Maps application did in the past provide these described results, it has been more recently corrected, perhaps due to complaints, to provide a result of ‘Did you mean Starbucks?’. While the more popular and nationally known businesses may be empirically corrected for in later searches, searches for less well known business names will not be presumed.

None of these conventional searching systems or methods provided POIs named “Starbucks”. In fact, none of the results provided with conventional inexact string searches provided anything useful as a result to the intended search. Oftentimes, using conventional techniques, the ‘Did you mean’ suggested alternative search notwithstanding, if the business name or other POI is misspelled, the user must submit a second search to be assured the results of interest.

In addition, an inexact string match on a large dataset may be quite slow as some kind of edit distance calculation is likely required to score and cull each possible match.

There is a need for an improved point-of-interest search that assists the user in the event that they provide inexact search criteria.

### SUMMARY OF THE INVENTION

In accordance with the principles of the invention, a Point-Of-Interest (POI) search engine for a mapping device comprises a POI database comprising a plurality of POIs. Each POI includes a name substring index, and a spatial index. An inexact string match and proximity search module retrieves a plurality of POIs from the POI database that inexactly match at least one of the substrings associated therewith to an input search request having a desired proximity to a current location.

A method of loading a Point-Of-Interest (POI) database into a navigation system in accordance with another aspect of the invention comprises loading a plurality of POI listings into a POI listings database. A spatial index for each POI listing is provided. Each of the plurality of POI listings is indexed into an inexact string match substring index, each entry having a given number of adjacent alphanumeric characters contained within the respective POI listing. In the academic literature, this adjacent substring indexing scheme is referred to as a QGRAM index.

### BRIEF DESCRIPTION OF THE DRAWINGS

Features and advantages of the present invention will become apparent to those skilled in the art from the following description with reference to the drawings, in which:

FIG. 1 shows an exemplary business listing loader, in accordance with the principles of the present invention.

FIG. 2 shows an exemplary search system using inexact string match and proximity search, in accordance with the principles of the present invention.

FIG. 3 is a conventional example showing the results provided by GOOGLE™ Maps at maps.google.com, wherein a ‘Find business’ search is performed with ‘What’=‘Starbocks’ and ‘Where’=‘Berkeley, Calif.’.

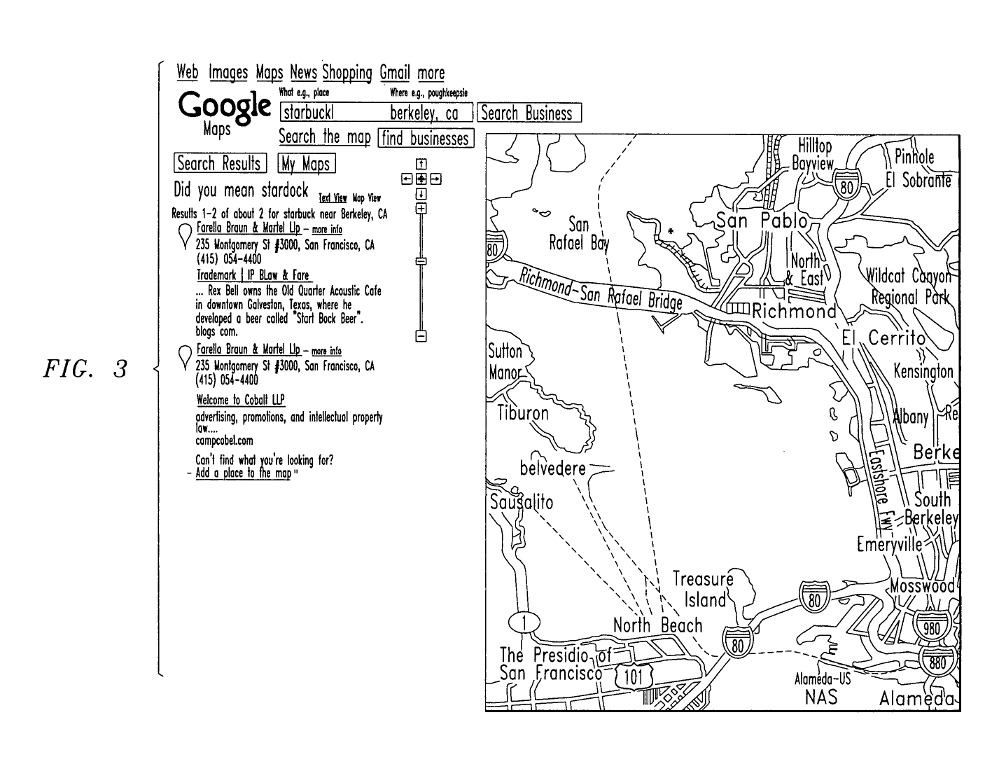

### DETAILED DESCRIPTION OF ILLUSTRATIVE EMBODIMENTS

This invention provides a point-of-interest mapping search system that combines inexact string searches with a proximity search to provide an extremely high probability of return of a set of search results in an initial search response that are useful to the user. The results are much more likely to provide relevant and useful POI information as compared with a conventional initial response including a conventional ‘Did you mean’ alternative search suggestion.

In accordance with the principles of the present invention, relevance of any particular point-of-interest item in a combined inexact string/proximity search in accordance with the principles of the present invention is preferably dependent on both (1) a quality of the name match; and (2) a proximity to the starting location (or other relevant search center point) of the POI search.

Because inexact string search is a relatively expensive operation in terms of processing and time required, the inventors herein have appreciated that a significant challenge in arriving at the present invention was in determining how much area to search around a relevant search point before returning the most relevant set of results.

The searched area was a circle centered at a given search point. Of course, other search shapes could be used, such as rectangular, triangular (with a point of the triangle at the given search point and the area enlarging transversely as it gets farther from the given search point, etc.

The present invention provides return of a most relevant set of proximity search results on the first attempt by combining a proximity search about a given search point (e.g., the current location of the user, their vehicle, etc.) with an inexact string matching result return module as is otherwise known in the art.

In accordance with the invention, it is the combination of the use of a combined inexact string match together with a proximity search performed against a database of geo-referenced business names that provides advantageous results.

The inexact string name/proximity search is performed efficiently by iteratively expanding a search radius around a given location (e.g., the current location of an automobile, a future location of an automobile as it travels a planned route, etc.), searching concentric circles of proximity until a specified target number of relevant results have been found. The target number may have a minimum default value (e.g., 1 matched result returned), and/or may be configurable by the factory and/or user to any desired minimum number of matched results returned.

### Database Load

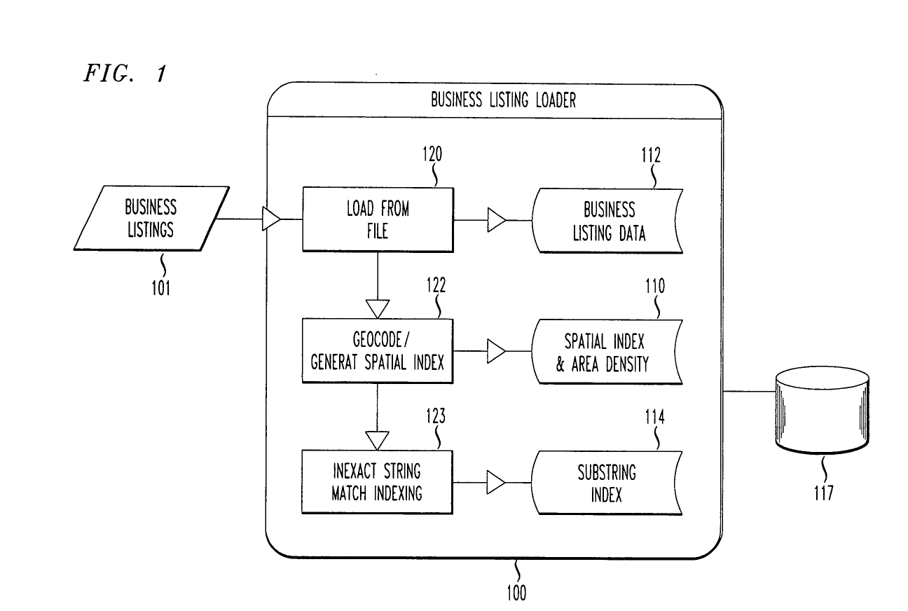

FIG. 1 shows an exemplary business (or other searched POI category) listing loader 100, in accordance with the principles of the present invention.

In particular, as shown in FIG. 1, business listings and other point-of-interest categories to be searched 101 are loaded by a loader module 120 into the system database 117 as business listing data 112.

The input business listings and other POI information are also geocoded by a Geocode/spatial indexing module 122. Geocoding is the process by which a street address is translated into a latitude/longitude by comparing the street address against a map database. The latitude/longitude of each entered POI is further transformed into a spatial index value that is used to quickly retrieve business listings within a defined area. A count of businesses (or other requested POI category information) with the same spatial index is also maintained and stored in the spatial index & area density portion 110 of the system database 117, for use during a subsequent POI inexact string/proximity search by the user as a measure of density.

The business listings (and other POI searchable categories) 101 are also indexed for inexact string match by an inexact string match indexing module 123. In the disclosed embodiments, each indexed name is partitioned into overlapping 3 character substrings that are added to an index table that associates a given 3 character substring. While a 3 character length was chosen by the present inventors, a greater length character overlap (e.g., 4 characters) is also within the principles of the present invention.

With respect to the 3 character overlap, take for example the 3 character string ‘STA’. The substring index table 114 would be loaded with every business name (or other POI category information) that contains that substring.

### Search

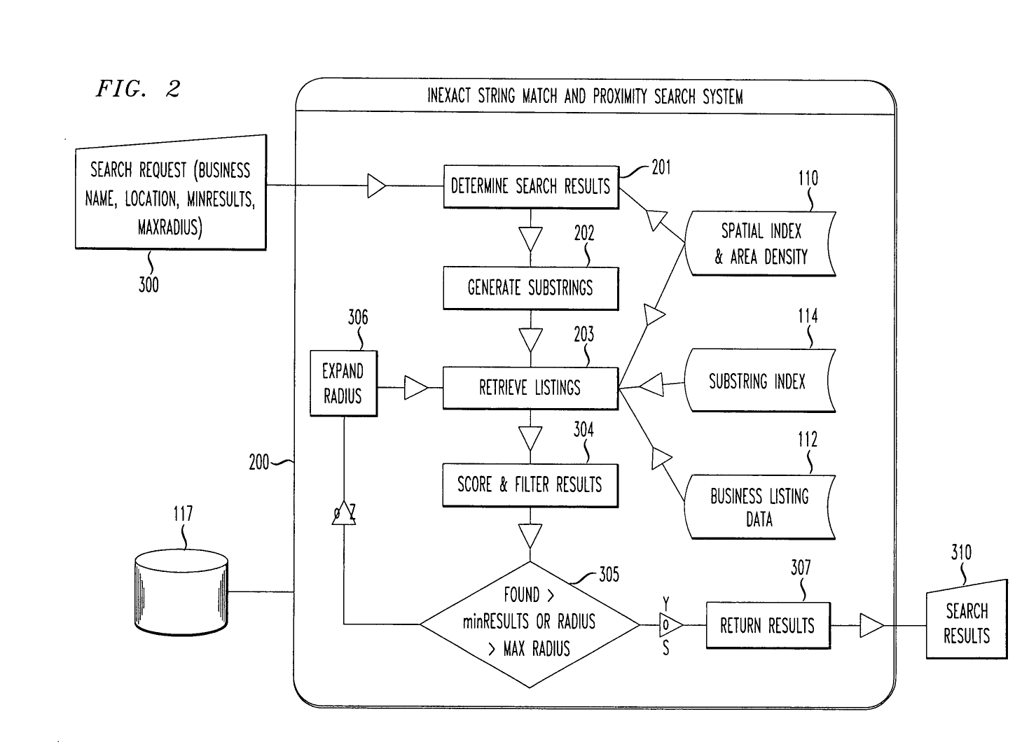

FIG. 2 shows an exemplary search system using inexact string match and proximity search, in accordance with the principles of the present invention.

In particular, FIG. 2 shows an inexact string match and proximity search system 200 that accepts appropriate search input 300, and outputs relevant search results 310.

Exemplary input 300 to the inventive inexact string/proximity POI search system 200 includes both location and search string. The location is preferably input as a latitude/longitude, or an address that is geocoded into a latitude/longitude. The search string is preferably input as an alphanumeric text string, e.g., ‘STARBUCKS’.

The input request 300 preferably also includes a parameter for a minimum number of results, and a parameter for the maximum radius of search. These parameters may be included in the input request 300 itself, or may be set globally by a default or user-configurable value accessible by the inexact string match and proximity search system 200. An exemplary parameter for the minimum number of results is, e.g., 25. An exemplary parameter for the maximum radius of search is, e.g., 50 miles. The maximum radius of search may be adjusted based on the speed of the user (e.g., if they are in a car).

The inexact string match and proximity search system 200 performs an inexact string/proximity POI search process for a mapping device, preferably as follows:

Step 201: Determine an initial search radius based on a density of businesses (or other searchable POI category) around the Location as recorded by the spatial index counts. Preferably smaller search areas are used for denser areas. For example, in Manhattan, the initial search radius might be 0.5 miles while in Bozeman, Mont., the initial search radius might be 10 miles. A default value for search area may be factory and/or user configurable.

Step 202: Partition the Search String into all of its component character substrings, e.g., 3 character substrings. As an example, ‘STARBUCKS’ would be broken into ‘STA’, ‘TAR’, ‘ARB’, ‘RBU’, ‘BUC’, ‘UCK’ and ‘CKS’.

Step 203: Retrieve all business (or other searchable POI category) listings within the initial search radius that contain at least one of the substrings from the Search String. Score all the business names against the Search String using a string edit distance calculation (Levenstein).

Step 304: Determine a Best Score within this group of results, and filter out all POI candidates with a score less than (Best Score—RelativeScoreRange) or less than MinScoreThreshold. This keeps all the best available (within some score range) unless they have a score less than some minimum threshold.

Step 305: While the total number of POI candidates is less than Minimum number of results and the current search radius is less than Maximum radius of search, expand the search radius and repeat.

In particular, in Step 306: Expand the search radius. The search radius is preferably increased a proportional amount based on density in the area proximate the input location. As an example, the search radius may be doubled.

To expedite processing, only the previously unsearched, or added, area need be searched. Thus, preferably only the ‘donut area’ between the old and new search radius need be searched. Of course, the entire new search area may be searched fresh for the new search radius if processing power permits.

All business listings (or other searchable POI candidates) are retrieved within the initial search radius that contain at least one of the substrings from the Search String. Then all the business names (or other searchable POI category) are scored against the Search String using a string edit distance calculation (as is otherwise conventionally known, e.g., as taught by Levenstein).

These results are added to previously found candidates.

A new BestScore is determined.

All candidates with a score less than (Best Score—RelativeScoreRange) or less than MinScoreThreshold, are filtered out.

Ultimately, as depicted in Step 307, the results are returned as search results 310.

Following is an actual example of a misspelled ‘Starbocks’ proximity search (when intending to search for “Starbucks”) using the inexact string match technologies described herein. The URL and sample results are listed below with some fields omitted for clarity:

In disclosed embodiments a proximity search for POI names combining inexact string match with an expanding radius search is performed on a server that is queried by a navigation system over a wireless connection. However, the proximity search may be performed locally in accordance with the principles of the present invention.

The invention provides a selection of results that is based on scores relative to the best score. If the best score improves as the radius expands, results that were previously deemed good enough to return may get filtered out.

The invention has particular applicability to developers of location enabled wireless devices and applications.

While the invention has been described with reference to the exemplary embodiments thereof, those skilled in the art will be able to make various modifications to the described embodiments of the invention without departing from the true spirit and scope of the invention.

What is claimed is:

1. A Point-Of-Interest (POI ) search engine for a mapping device, comprising:
a POI database comprising a plurality of POIs, each POI including a name substring index, and each POI including a spatial index; and
an inexact string match and proximity search module to retrieve a plurality of POIs from said POI database that inexactly match at least one of said substrings associated therewith to an input search request having a desired proximity to a current location.

2. The Point-Of-Interest (POI) search engine for a mapping device according to claim 1, wherein said plurality of POIs each further comprise:
a value for area density

3. The Point-Of-Interest (POI) search engine for a mapping device according to claim 1, wherein:
said mapping device is a navigation system for an automobile.

4. The Point-Of-Interest (POI) search engine for a mapping device according to claim 1, wherein:
said mapping device is a phone-based wireless application for local search.

5. The Point-Of-Interest (POI) search engine for a mapping device according to claim 1, further comprising:
scoring relevant POIs against said input search request using a string edit distance calculation.

6. A method of loading a Point-Of-Interest (POI) database into a navigation system, comprising:
loading a plurality of POI listings into a POI listings database;
providing a spatial index for each POI listing; and
indexing each of said plurality of POI listings into an inexact string match substring index, each entry having a given number of adjacent alphanumeric characters contained within said respective POI listing.

7. The method of loading a Point-Of-Interest (POI) database into a navigation system according to claim 6, wherein:
said given number of adjacent alphanumeric characters is three.

8. The method of loading a Point-Of-interest (POI) database into a navigation system according to claim 6, further comprising:
providing an area density for each POI listing.

9. Apparatus for loading a Point-Of-Interest (POI) database into a navigation system, comprising:
means for loading a plurality of POI listings into a POI listings database;
means for providing a spatial index for each POI listing; and
means for indexing each of said plurality of POI listings into an inexact string match substring index, each entry having a given number of adjacent alphanumeric characters contained within said respective POI listing.

10. The apparatus for loading a Point-Of-Interest (POI) database into a navigation system according to claim 9, wherein:
said given number of adjacent alphanumeric characters is three.

11. The apparatus for loading a Point-Of-Interest (POI) database into a navigation system according to claim 9, further comprising:
means for providing an area density for each POI listing.
